(19) United States
(12) Patent Application Publication
(10) Pub. No.: US 2017/0265103 A1
(43) Pub. Date: Sep. 14, 2017

(54) COMMUNICATION DEVICE, COMMUNICATION METHOD, AND NON-TRANSITORY COMPUTER READABLE MEDIUM

(71) Applicant: KABUSHIKI KAISHA TOSHIBA, Tokyo (JP)

(72) Inventors: Yuta KOBAYASHI, Kawasaki (JP); Takahiro YAMAURA, Kawasaki (JP); Kensaku YAMAGUCHI, Kawasaki (JP)

(21) Appl. No.: 15/260,545

(22) Filed: Sep. 9, 2016

(30) Foreign Application Priority Data
Mar. 9, 2016 (JP) 2016-046148

(51) Int. Cl. H04W 28/14; H04L 29/06

(52) U.S. Cl. CPC H04W 28/14; H04L 69/161; H04L 69/22

(57) ABSTRACT

According to one embodiment, a communication device includes a communication processor configured to execute at least one of transmission processing and reception processing of a packet; a writer circuitry configured to write data included in the packet to a buffer; a reader circuitry configured to read the data from the buffer; and processing circuitry configured to stop at least part of the write to the buffer, change the buffer after the buffer becomes empty, and restart the write to the changed buffer.

### CROSS-REFERENCE TO RELATED APPLICATIONS

This application is based upon and claims the benefit of priority from Japanese Patent Application No. 2016-046148, filed on Mar. 9, 2016; the entire contents of which are incorporated herein by reference.

### FIELD

Embodiments described herein relate to a communication device, a communication method and a non-transitory computer readable medium.

### BACKGROUND

Communication devices mounted on server devices, terminal devices, etc. generally utilize Ethernet (registered tradename), 802.11a/b/g/n/ac, etc. as protocols of MAC layers and physical layers and utilize TCP/IP, UDP/IP, etc. widely used by the Internet, etc. as the protocols of upper layers.

The mainstream of Ethernet is currently 1 Gbps, and data centers, etc. started using Ethernet of 10 Gbps or 40 Gbps. The development of specifications of next-generation Ethernet of 100 Gbps has been also completed. Also in IEEE 802.11, utilization of several Gbps is expected to be common in the future.

As high-speed networks like this become common, processing performance of CPUs (Central Processing Units) and computational resources required in communication processing such as memory bands are increasing. The increase of the computational resources causes increase of cost, consumed electric power, etc.

Conventionally, in order to reduce the processing load of a host processor or the band of a system memory, dedicated hardware such as a TCP/IP offload engine (hereinafter, referred to as “TOE”) has been used. TOE is a device provided with a dedicated processor or a dedicated circuit which carries out protocol processing of TCP/IP in place of a host processor. When TOE is used, the protocol processing of TCP/IP can be offloaded from the host processor, and the protocol processing is enabled to be carried out at a speed higher than the protocol processing by conventional software.

Incidentally, in protocol processing, a transmission/reception buffer for temporarily retaining transmission/reception data taken out from transmission/reception packets has to be reserved in a storage area of, for example, a system memory. Conventional TOE has fixedly reserved a large-size transmission/reception buffer for each session. By virtue of this, TOE has been able to efficiently carry out transmission/reception processing. However, in this method, the transmission/reception buffer is reserved even while TOE is not carrying out the transmission/reception processing. Therefore, there has been a problem that the usage efficiency of the memory is low.

In order to increase the usage efficiency of the memory, TOE which reserves a transmission/reception buffer when the connection of TCP/IP is established has been also proposed. However, in this TOE, since dynamic control of a buffer size cannot be carried out, the usage efficiency of the memory has been still low compared with the protocol processing which is carried out by software capable of dynamically controlling the buffer size.

### BRIEF DESCRIPTION OF THE DRAWINGS

FIG. 1 is a diagram showing an example of a communication device according to a first embodiment;

FIG. 2 is a flow chart showing an example of a normal reception operation of the communication device;

FIG. 3 is a diagram showing an example of a ring buffer;

FIG. 4 is a flow chart showing an example of a change operation of a reception buffer according to the first embodiment;

FIG. 5 is a state transition diagram showing transitions of a reception state in the first embodiment;

FIG. 6 is a diagram showing an example of a reception buffer in which an empty area is generated between two used areas;

FIG. 7 is a diagram showing an example of buffer information managed by sequence numbers;

FIG. 8 is a flow chart showing an example of a change operation of the reception buffer according to a second embodiment;

FIG. 9 is a state transition diagram showing transitions of the reception state in the second embodiment;

FIG. 10 is a flow chart showing an example of a change operation of the reception buffer according to a third embodiment;

FIG. 11 is a flow chart showing an example of a change operation of a reception buffer according to a fourth embodiment;

FIG. 12 is a state transition diagram showing transitions of a reception state in the fourth embodiment;

FIG. 13 is a sequence diagram showing an example of transmission/reception of packets according to the fourth embodiment;

FIG. 14 is a sequence diagram showing an example of transmission/reception of packets according to the fourth embodiment;

FIG. 15 is a diagram showing an example of a communication device according to a fifth embodiment;

FIG. 16 is a flow chart showing an example of a normal transmission operation according to the fifth embodiment; and

FIG. 17 is a flow chart showing an example of a change operation of a transmission buffer according to the fifth embodiment.

### DETAILED DESCRIPTION

According to one embodiment, a communication device includes a communication processor configured to execute at least one of transmission processing and reception processing of a packet; writer circuitry configured to write data included in the packet to a buffer; reader circuitry configured to read the data from the buffer; and processing circuitry configured to stop at least part of the write to the buffer, change the buffer after the buffer becomes empty, and restart the write to the changed buffer.

Hereinafter, embodiments of the present invention will be described with reference to drawings.

### First Embodiment

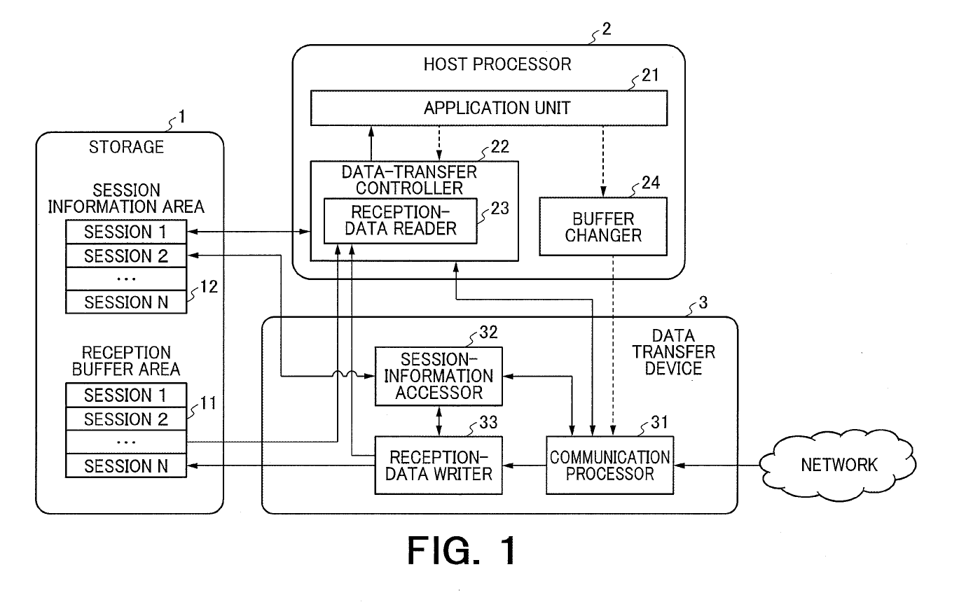

A communication device according to a first embodiment will be described with reference to FIG. 1 to FIG. 5. The communication device according to the present embodiment receives packets from external devices (other communication devices of a transmission side) connected via a network, executes protocol processing with respect to the received packets, stores the data obtained by the protocol processing into a reception buffer, and executes applications by utilizing the data stored in the reception buffer. The communication device according to the present embodiment is capable of dynamically controlling the size of the reception buffer during reception processing.

The above described network includes an arbitrary wired communication network and wireless communication network such as Ethernet and wireless LAN. Hereinafter, the packets received by the communication device will be referred to as reception packets, and the data obtained by executing protocol processing with respect to the reception packets will be referred to as reception data. The communication device may receive frames instead of the packets.

The communication device according to the present embodiment consists of, for example, a PC, a server device, a dedicated LSI, a FPGA (Field Programmable Gate Array), or an ASIC (Application Specific Integrated Circuit), but is not limited thereto.

FIG. 1 is a diagram showing an example of the communication device according to the present embodiment. The communication device of FIG. 1 is provided with a storage 1, a host processor 2, and a data transfer device 3 which is a hardware data transfer.

The storage 1 is, for example, a SRAM (Static Random Access Memory), a SDRAM (Synchronous Dynamic Random Access Memory), a SSD (Solid State Drive), a HDD (Hard Disk Drive), or a SD card, but is not limited thereto. The storage 1 is provided with a reception buffer area 11 and a session information area 12.

The reception buffer area 11 is a storage area provided with reception buffers of sessions. The reception buffers of the sessions temporarily store reception data received in the sessions, respectively. In the example of FIG. 1, the reception buffers of a session 1 to a session N are provided in the reception buffer area 11.

The session information area 12 is a storage area which stores session information of the sessions. The session information is the information for managing the sessions and is utilized by the data transfer device 3 in order to execute protocol processing (generation of headers of transmission packets, analysis of headers of reception packets, etc.).

For example, when the data transfer device 3 executes protocol processing of TCP/IP, the session information includes: a destination IP address, a source IP address, a destination port number, a source port number, sequence numbers, ACK numbers, etc. The session information includes buffer information. The buffer information is the information for managing buffers and includes the positions (addresses), sizes, used areas, empty areas, etc. of the buffers. In the present embodiment, the buffer information includes the buffer information of the reception buffers.

In the example of FIG. 1, the communication device is provided with the single storage 1, but may be provided with a plurality of storages. In this case, the reception buffer area 11 and the session information area 12 may be provided in mutually different storages, respectively. In the present embodiment, the storage 1 may be provided with a storage area for storing the buffer information of the sessions separately from the session information area 12.

The host processor 2 is, for example, a CPU, which is electric circuitry, and carries out control of the entire communication device. The host processor 2 is provided with an application unit 21, a data-transfer controller 22, a reception-data reader 23, and a buffer changer 24. These functions are realized by executing corresponding software by the host processor 2. The elements 21-24 may be implemented by a physically same circuitry or different circuitry. As one example, the reception-data reader 23 corresponds to reader circuitry, and the buffer changer 24 corresponds to processing circuitry.

The application unit 21 is realized by executing a predetermined application by the host processor 2. The application is arbitrary as long as it acquires data from external devices. The external device is, for example, a file server or a cache proxy, but is not limited thereto. The application unit 21 requests data to the external device and executes predetermined processing by utilizing the reception data obtained in response to the request.

The data-transfer controller 22 (hereinafter, referred to as “controller 22”) executes reception processing including establishment and disconnection of communication connections and protocol processing. The controller 22 requests the data transfer device 3 to act for part of or all of the reception processing of the data requested by the application unit 21. The controller 22 does not carry out the reception processing about the sessions for which the data-transfer device 3 is request to act for the reception processing.

The controller 22 generates the session information, which includes the buffer information, for each session and stores the information in the session information area 12. As a result, a reception buffer is reserved for each session. The size of the reception buffer reserved by the controller 22 may be a fixed length or may be specified by the application unit 21. The controller 22 of FIG. 1 is provided with the reception-data reader 23.

The reception-data reader 23 (hereinafter, referred to as “reader 23”) reads the reception data, which is written to the reception buffer, and passes the reception data to the application unit 21. The application unit 21 executes predetermined processing by utilizing the reception data received from the reader 23.

In the example of FIG. 1, the reader 23 is provided in the controller 22. This is for a reason that the function of the reader 23 is expected to be part of the function of the software which realizes the function of the controller 22. However, in the present embodiment, the reader 23 may be provided independently from the controller 22. More specifically, the function of the controller 22 and the function of the reader 23 may be realized by mutually different software.

The buffer changer 24 (hereinafter, referred to as “changer 24”) updates the buffer information and changes the size of the reception buffer in accordance with a change order of the reception buffer from the application unit 21. When the reception buffer is to be changed, the changer 24 controls the data transfer device 3 in accordance with the state of the reception buffer. A control method of the data transfer device 3 will be described later in detail.

The application unit 21 may cooperate with a memory management mechanism of an OS (Operating System) and give the order to change the reception buffer in accordance with a usage state of the storage 1 or may give the order to change the reception buffer in accordance with network throughput. The buffer change order may be given by a dedicated application executed by the host processor 2.

The data transfer device 3 (hereinafter, referred to as “transfer device 3”) executes protocol processing with respect to the reception packet about the session (connection) for which the reception processing has been requested from the controller 22 in place of the host processor 2. Specifically, the transfer device 3 analyzes a header of the reception packet, extracts the reception data stored in the reception packet, and writes the extracted reception data to a predetermined reception buffer.

The transfer device 3 may be formed by dedicated hardware or may be formed by executing software by a general-purpose processor. However, in order to improve processing efficiency, the transfer device 3 is preferred to be formed by dedicated hardware such as TOE. The transfer device 3 is provided with a communication processor 31, a session-information accessor 32, and a reception-data writer 33. The elements 31 to 33 may be implemented by a physically same circuitry or different circuitries.

The communication processor 31 communicates with the external devices by utilizing the session information generated by the controller 22, receives the reception packets from the external devices, and executes predetermined protocol processing with respect to the reception packets. The communication processor 31 may execute protocol processing of TCP/IP or may execute protocol processing of UDP/IP. The communication processor 31 may execute Ethernet processing, wireless processing, etc. together with the protocol processing. The session-information accessor 32 (hereinafter, referred to as “accessor 32”) is a processor for the transfer device 3 to access the session information area 12. The communication processor 31 and the reception-data writer 33 acquire and update the session information via the accessor 32. If the transfer device 3 is capable of directly accessing the session information from the session information area 12, the transfer device 3 is not required to be provided with the accessor 32.

The reception-data writer 33 (hereinafter, referred to as “writer 33”) writes the reception data, which is extracted by the communication processor 31, to the predetermined reception buffer reserved by the controller 22 by utilizing the buffer information. The writer 33 accesses the buffer information via the accessor 32.

Next, operations of the communication device according to the present embodiment will be described. Hereinafter, a normal reception operation of the communication device and a change operation of the reception buffer will be described.

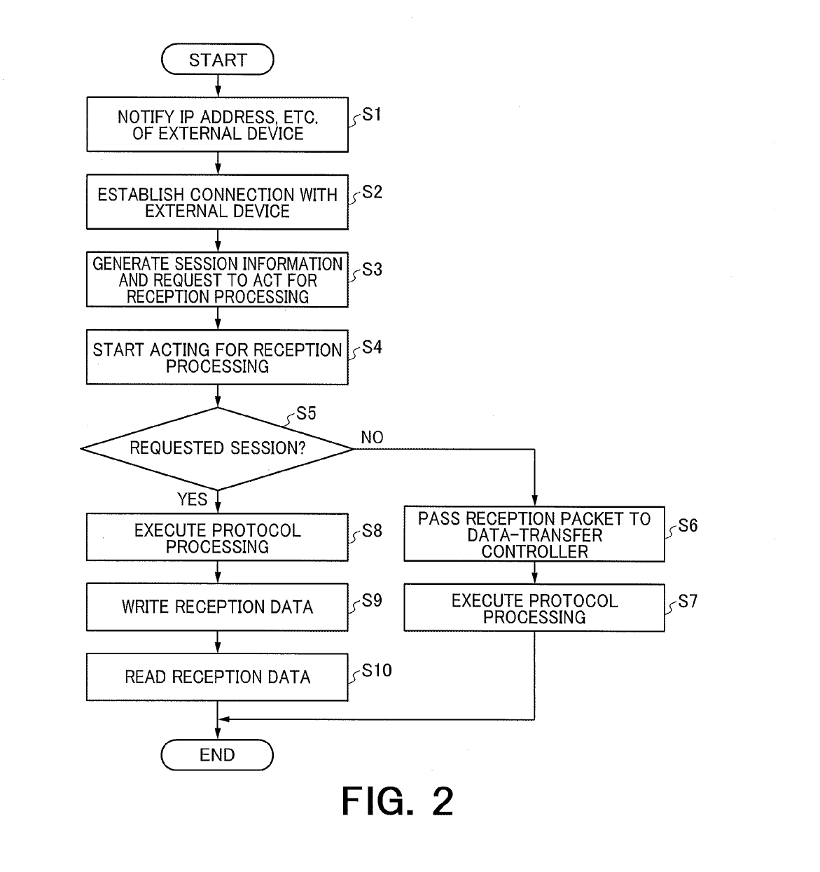

FIG. 2 is a flow chart showing an example of a normal reception operation of the communication device. Hereinafter, a case in which protocol processing of TCP/IP is executed with respect to reception packets is taken an example for description. In the case of TCP/IP, each session is managed by four pieces of information, i.e., “destination IP address”/“source IP address” and “destination port number”/“source port number”. First, the application unit 21 notifies the information required for reception of data such as an IP address and a port number of the external device to the controller 22 and orders the controller 22 to receive data (step S1).

Then, the controller 22 establishes a connection to the external device in accordance with the order from the application unit 21 (step S2).

When the establishment of the connection is completed, the controller 22 generates session information of the established connection and stores the generated session information in the session information area 12. The controller 22 requests the transfer device 3 to act for the reception processing in the session corresponding to the established connection (step S3). Hereinafter, the session for which the transfer device 3 is requested by the controller 22 to act for reception processing will be referred to as an acting session.

In this process, the controller 22 reserves a reception buffer, which temporarily stores the reception data of the acting session, in the reception buffer area 11. The buffer information of the reserved reception buffer is included in the session information of the acting session. Reception/transmission of the reception data between the controller 22 and the transfer device 3 is carried out via this reception buffer. A management method of the reception buffer for receiving/transmitting the reception data will be described later in detail.

The communication processor 31 requested to act therefor starts acting for the reception processing of the acting session and sequentially receives the packets transmitted from the external device via the network (step S4).

Then, the communication processor 31 executes reception processing with respect to the reception packets. Specifically, the communication processor 31 analyzes headers of the reception packets, checks the IP address and the port number, and judges whether the reception packets are the packets of the acting session or not (step S5).

If the reception packets are not the packets of the acting session (NO in step S5), the communication processor 31 passes the reception packets to the controller 22 (step S6).

The controller 22, which has received the reception packets, executes reception processing including protocol processing with respect to the received reception packets (step S7).

On the other hand, if the reception packets are the packets of the acting session (YES in step S5), the communication processor 31 acquires the session information of the acting session via the accessor 32 and executes protocol processing of TCP/IP based on the acquired session information (step S8).

Specifically, the communication processor 31 checks the buffer information and the sequence numbers of the reception packets and judges whether the reception packets can be received or not. Examples of the case in which they cannot be received include a case in which the reception buffer does not have an empty area, a case in which the sequence number of the reception packet is inappropriate, and a case in which a checksum of the reception packet is inappropriate.

If the reception packets can be received, the communication processor 31 extracts the reception data from the reception packets, passes the extracted reception data to the writer 33, and updates the session information (sequence number, etc.) of the acting session. The communication processor 31 generates ACK packets, which indicate that data has been received, and transmits the generated ACK packets to the external device via the network.

The writer 33, which has received the reception data, writes the received reception data to the reception buffer of the acting session (step S9). When the write of the reception data is completed, the writer 33 updates the buffer information of the acting session.

The writer 33 notifies a fact that the reception data is written to the reader 23 by utilizing, for example, an interrupt signal. The writer 33 may give the notification every time the write of the reception data is completed or may give the notification every time the size of the reception data written to the reception buffer exceeds a predetermined size. The predetermined size may be set in advance or may be notified from the controller 22 when the connection is established. The reader 23 to which the fact that the reception data has been written is notified reads the buffer information of the acting session from the session information area 12, reads the reception data from the reception buffer of the acting session based on the read buffer information, and passes the read reception data to the application unit 21 (step S10). The reader 23 reads the reception data, then frees the reception buffer of the acting session, and updates the buffer information of the acting session.

Then, the controller 22 generates “ACK”, which gives a notification of a current window size of the acting session (size of an empty area of the reception buffer), and transmits that to the external device via the network. The transmission of this “ACK” may be carried out by the communication processor 31. In this case, the reader 23 can notify the update of the buffer information to the communication processor 31.

By the reception operation above, the transfer device 3 can execute the reception processing of the acting session in place of the host processor 2. In the same connection, the reception data is received/transmitted by utilizing the same reception buffer; therefore, the transfer device 3 can efficiently pass the reception data to the host processor 2.

Herein, the management method of the reception buffer will be described. Hereinafter, description will be given by taking a case in which the reception buffer is a ring buffer as an example. However, the reception buffer is not limited to a ring buffer.

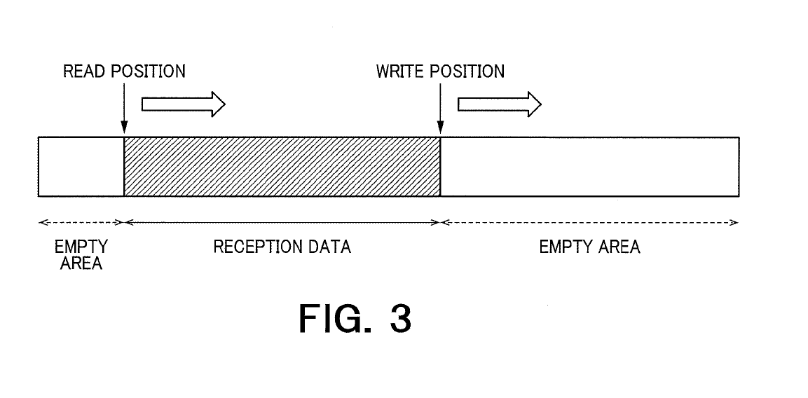

FIG. 3 is a diagram showing an example of the ring buffer. In the ring buffer (reception buffer) of FIG. 3, hatching represents an area in which the reception data is written (hereinafter, referred to as “used area”), and other parts are areas in which the reception data is not written (hereinafter, referred to as “empty areas” or “available areas”). When the ring buffer is utilized, the buffer information includes a read position, a write position, and correspondence relations of addresses of the ring buffer and sequence numbers.

The write position is a position in the reception buffer from which write of new reception data by the writer 33 is started. The write position is managed, for example, as a sequence number of TCP/IP or an address in the reception buffer. The data transfer device 3 has the correspondence relations of the addresses of the ring buffer and sequence numbers (for example, the sequence number of the read position and the address of the ring buffer) in the buffer information, updates the correspondence relations when the write position or the read position circulate the ring buffer, is therefore capable of calculating the corresponding address from the sequence number of the reception packet. When the reception data is to be written, the writer 33 starts write of the reception data from the write position included in the current buffer information. Then, after completion of the write, the writer 33 updates the write position included in the buffer information. In the example of FIG. 3, the write position is updated in the direction of an arrow. The used area after completion of the write is a continuous area from the original write position to the write position after update.

The read position is a position in the reception buffer from which read of the reception data by the reader 23 is started. The read position is managed, for example, as a sequence number of TCP/IP or an address in the reception buffer. When the reception data is to be read, the reader 23 reads the reception data from the read position to the write position included in the current buffer information. Then, after the read is completed, the reader 23 updates the read position included in the buffer information. In the example of FIG. 3, the read position is updated in the direction of an arrow. When the reader 23 updates the read position, the read position and the write position match each other, and the used area is freed.

The reception data can be received/transmitted between the host processor 2 and the transfer device 3 by updating the buffer information in the above manner.

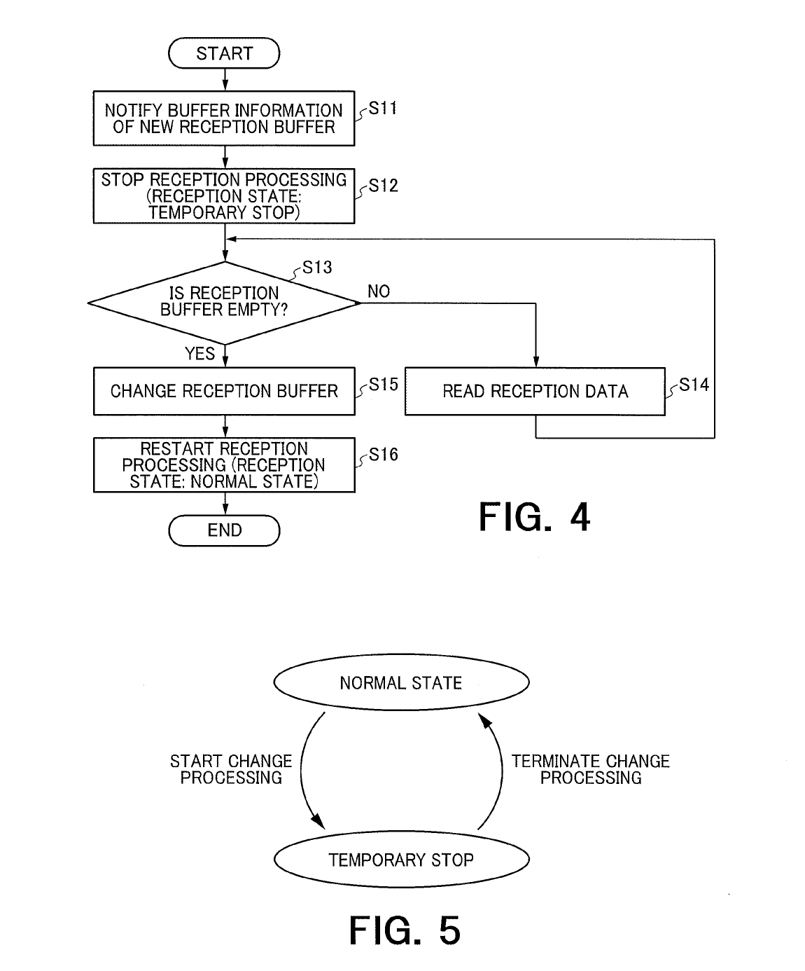

FIG. 4 is a flow chart showing an example of the change operation of the reception buffer of the communication device according to the present embodiment. The change operation of the reception buffer is carried out during execution of the reception processing by the communication processor 31.

First, the application unit 21 specifies a session for which the reception buffer is changed among the acting session(s) and orders the buffer changer 24 to change the reception buffer. In this process, the application unit 21 notifies the buffer information of the new reception buffer after the change to the buffer changer 24 (step S11). Hereinafter, the acting session for which the reception buffer is changed will be referred to as a target session.

The application unit 21 may reserve a new reception buffer in the reception buffer area 11 and notify the buffer information of the reserved reception buffer. Alternatively, the application unit 21 may notify the size of the new reception buffer without reserving the new reception buffer. In this case, the new reception buffer can be reserved by the buffer changer 24.

The buffer changer 24 ordered to change the reception buffer stops the reception processing of the target session by the communication processor 31 (step S12). As a result, write of new reception data to the reception buffer is stopped. The control method of the transfer device 3 by the buffer changer 24 will be described later in detail.

After the reception processing is stopped, if the reception buffer is not empty (NO in step S13), the reader 23 continues to read the reception data from the reception buffer of the target session (step S14). When the reader 23 continues to read, the reception buffer becomes empty in the end.

When the reception buffer becomes empty (YES in step S13), the buffer changer 24 updates the buffer information of the target session based on the buffer information notified from the application unit 21 and changes the reception buffer of the target session to a new reception buffer (step S15).

Specifically, if the buffer information of the new reception buffer reserved by the application unit 21 has been notified, the buffer changer 24 can write the notified buffer information in the session information area 12 as the buffer information of the target session. If the size of the new reception buffer has been notified, the buffer changer 24 can reserve a new reception buffer having the notified size and write the buffer information of the reserved reception buffer in the session information area 12 as the buffer information of the target session.

The buffer changer 24 may detect the fact that the reception buffer has become empty by monitoring the state of the reception buffer of the target session or may be notified of the fact that the reception buffer has become empty by the reader 23.

The buffer changer 24 changes the reception buffer of the target session and then restarts the reception processing of the target session by the communication processor 31 (step S16). The control method of the transfer device 3 by the buffer changer 24 will be described later in detail.

Since the packet(s) transmitted from the external device while the reception processing is stopped is discarded, it appears to external equipment that a packet loss(es) has occurred. Therefore, when the communication processor 31 restarts the reception processing and the external device retransmits the packet(s), the reception processing of the target session can be recovered.

Herein, the method of controlling the transfer device 3 by the buffer changer 24 will be described. Hereinafter, as an example of the control method, a method in which the transfer device 3 is controlled by changing the session information by the buffer changer 24 will be described.

When this control method is utilized, the session information includes a reception state as the information indicating the state of the session. The communication processor 31 executes reception processing in accordance with this reception state.

FIG. 5 is a state transition diagram showing transitions of the reception state in the present embodiment. In the example of FIG. 5, the reception state can have two types of values, i.e., a normal state and a temporary stop. The communication processor 31 executes reception processing if the reception state is the normal state and stops reception processing if the reception state is the temporary stop.

Upon start of the change processing of the reception buffer, the buffer changer 24 can stop the reception processing, which is carried out by the communication processor 31, by changing the reception state of the target session from the normal state to the temporary stop (step S12). Upon termination of the change processing, the buffer changer 24 can restart the reception processing, which is carried out by the communication processor 31, by changing the reception state of the target session from the temporary stop to the normal state (step S16).

In this manner, the buffer changer 24 can control the communication processor 31 by changing the session information. However, the control method is not limited to this, and an arbitrary existing method can be employed.

As described above, the communication device according to the present embodiment can change the reception buffer of the target session during the reception processing of the target session. More specifically, the communication device according to the present embodiment can dynamically control the size of the reception buffer during the reception processing. By virtue of this, the size of the reception buffer can be controlled in accordance with the usage rate of the memory (the reception buffer area 11 of the storage 1), the network throughput, etc., and the usage efficiency of the memory can be improved.

The communication device according to the present embodiment can form the transfer device 3 by a TOE, which reserves reception buffers having fixed lengths. When the transfer device 3 is formed by such a TOE, the protocol processing is offloaded from the host processor 2, the protocol processing is speeded up, and the communication device having high usage efficiency of the memory can be realized.

### Second Embodiment

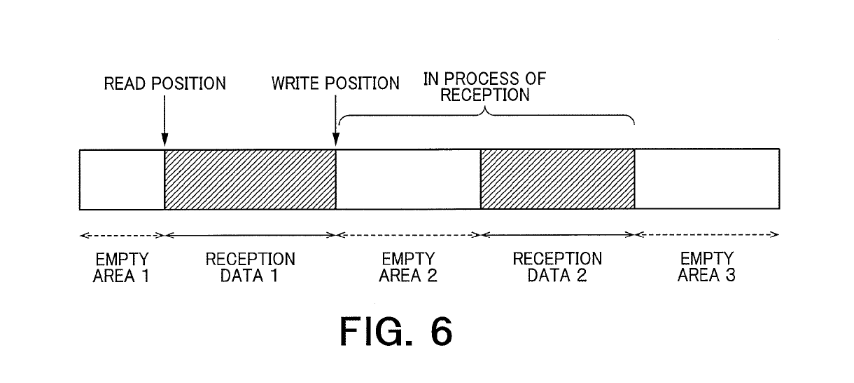

A communication device according to a second embodiment will be described with reference to FIG. 6 to FIG. 9. Since the configuration of the communication device according to the present embodiment is the same as that of the first embodiment, the description thereof is omitted. Hereinafter, it is assumed that the reception buffer is a ring buffer.

In a protocol like TCP/IP which ensures the sequence of reception packets, an empty area may be generated between two used areas in process of the reception processing. FIG. 6 is a diagram showing an example of the reception buffer in which an empty area is generated between two used areas. In the reception buffer of FIG. 6, an empty area 2 is formed between the used area to which reception data 1 is written and the used area to which reception data 2 is written. The empty area 2 like this can be generated during the reception processing of the reception data 2.

If the empty area 2 is generated upon change of the reception buffer, the reception buffer can be changed by discarding the reception data 2, which is in process of reception. However, if the reception buffer is changed by this method, the reception data 2, which has been received intermediately, has to be received again, and, therefore, the reception processing is wasted. If a SACK (Selective Acknowledgement) option of TCP is used, the sequence number of the reception data 2 is notified to the external device, and, therefore, the reception data 2 is not transmitted after the reception buffer is changed.

Therefore, in the present embodiment, a change method of the reception buffer capable of changing the reception buffer without discarding the reception data which is in process of reception will be described. In the present embodiment, the buffer information includes, a read position, a write position, empty-area information, and used-area information.

The empty-area information is the information indicating the position of an empty area after the write position in the reception buffer. The empty-area information includes a start point and an end point of the empty area. The start point of the empty area matches the write position, and the end point of the empty area matches a start point of a used area. The empty-area information is, for example, managed as sequence numbers of TCP/IP or addresses in the reception buffer.

The used-area information is the information indicating the position of a used area after the empty area in the reception buffer. The used-area information includes the positions of the start point and an end point of the used area. The start point of the used area matches the end point of the empty area. The used-area information is, for example, managed as sequence numbers of TCP/IP or addresses in the reception buffer.

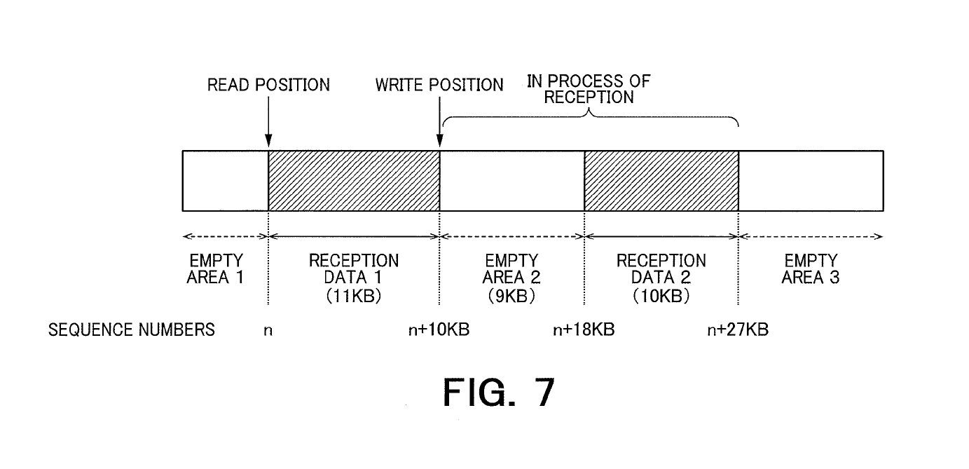

Hereinafter, it is assumed that the buffer information (the read position, the write position, the empty-area information, and the used-area information) is managed as sequence numbers. FIG. 7 is a diagram showing an example of the buffer information managed by sequence numbers. In the example of FIG. 7, the read position is “n”, the write position is “n+10 KB”, an empty area 2 is from “n+10 KB” (start point) to “n+18 KB” (end point), and the used area is from “n+18 KB” (start point) to “n+27 KB” (end point). Herein, in the example of FIG. 7, the empty area between the reception data is only the empty area 2. However, a plurality of empty areas may exist between reception data. The allowable maximum number of empty areas depends on the empty-area information and the used-area information included in the buffer information.

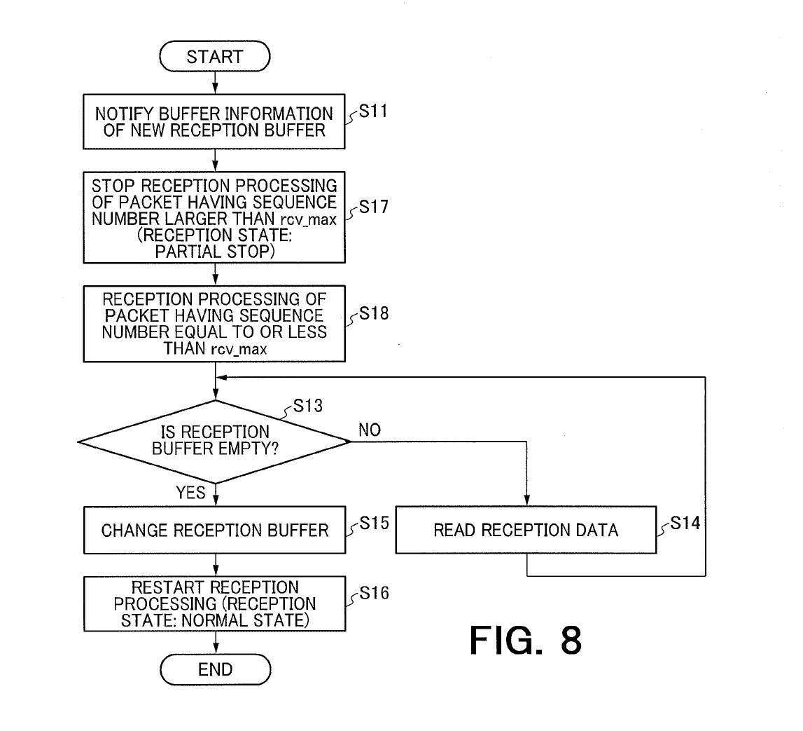

FIG. 8 is a flow chart showing an example of a change operation of the reception buffer according to the communication device according to the present embodiment. The flow chart of FIG. 8 is a flow chart in which steps S17 and S18 are added in place of step S12 of the flow chart of FIG. 4. Steps S11 and S13 to S16 of FIG. 8 are the same as those of FIG. 4. Hereinafter, steps S17 and 18 will be described.

In the present embodiment, the buffer changer 24 ordered to change the reception buffer stops part of the reception processing of the target session by the communication processor 31. Specifically, the buffer changer 24 stops the reception processing of the packet having a sequence number larger than a maximum sequence number (rcv_max) (step S17). The maximum sequence number referred to herein is a maximum value of the sequence numbers of the reception data received by the communication processor 31 and corresponds to the sequence number of the end point of the used area. In the example of FIG. 7, the maximum sequence number is “n+27 KB”.

When the reception processing is partially stopped, the communication processor 31 stops the reception processing of the packet having the sequence number larger than the maximum sequence number and continues the reception processing of the packet(s) having the sequence number(s) equal to or less than the maximum sequence number.

Specifically, the communication processor 31 judges whether the reception packet is a packet of the target session or not; and, if it is the packet of the target session, the communication processor 31 references the buffer information of the target session and compares the sequence number of the reception packet with the maximum sequence number.

If the sequence number of the reception packet is larger than the maximum sequence number, the communication processor 31 discards the reception packet without carrying out protocol processing. On the other hand, if the sequence number of the reception packet is equal to or less than the maximum sequence number, the communication processor 31 subjects the reception packet to protocol processing and passes the obtained reception data to the writer 33. Then, the writer 33 writes the received reception data to the reception buffer, notifies that to the reader 23, and updates the buffer information (write position, empty-area information, and used-area information) of the target session.

By virtue of this, the transfer device 3 can subject the reception packet which has the sequence number equal to or less than the maximum sequence number to reception processing and write the obtained reception data to the reception buffer (step S18). The reception data written in this manner is the reception data corresponding to the empty area. Therefore, when the write of this reception data is completed, the empty area is eliminated, and the used area becomes a continuous area from the read position to the write position.

The processing thereafter is the same as that of FIG. 4. More specifically, the reader 23 reads the reception data until the reception buffer of the target session becomes empty (step S14), the buffer changer 24 changes the reception buffer of the target session (step S15), and the buffer changer 24 causes the communication processor 31 to restart the reception processing (step S16).

Herein, the control method of the transfer device 3 by the buffer changer 24 will be described. Hereinafter, as well as the first embodiment, the method of controlling the transfer device 3 by changing the session information (reception state) by the buffer changer 24 will be described.

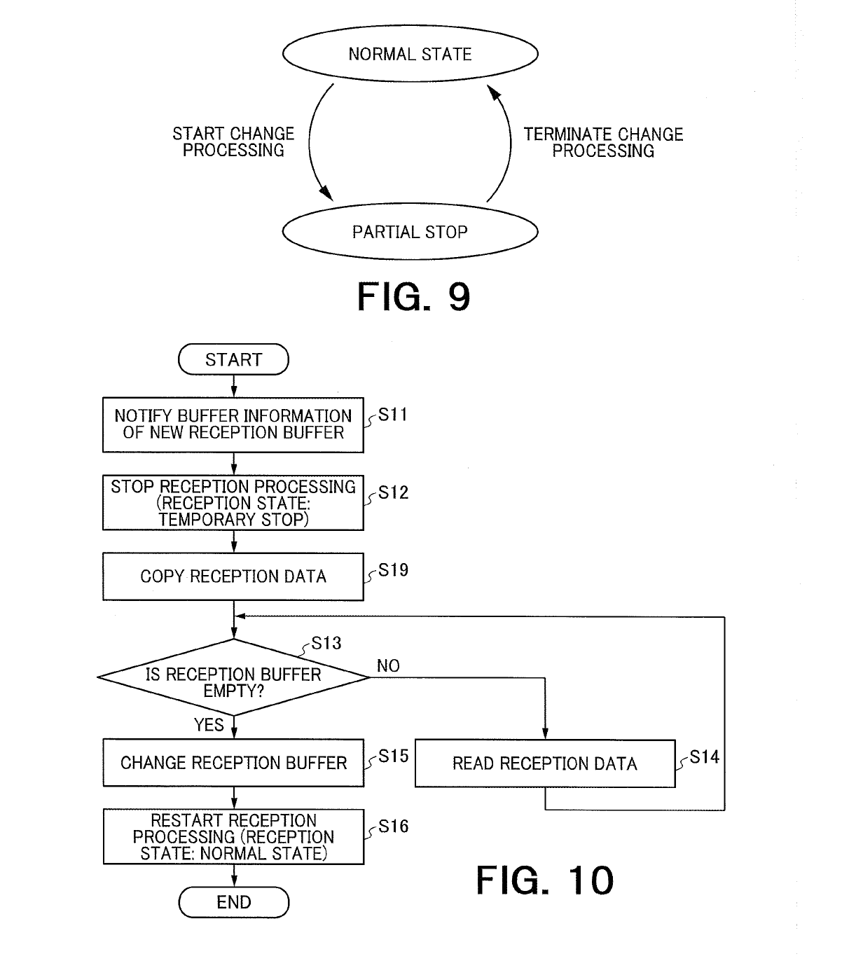

FIG. 9 is a state transition diagram showing transitions of the reception state in the present embodiment. In the example of FIG. 9, the reception state may have two types of values, i.e., a normal state and a partial stop. The communication processor 31 executes reception processing if the reception state is the normal state and stops the reception processing of the reception packet having the sequence number larger than the maximum sequence number if the reception state is the partial stop.

The buffer changer 24 can partially stop the reception processing, which is carried out by the communication processor 31, by changing the reception state of the target session from the normal state to the partial stop when the change processing of the reception buffer is started (step S17). The buffer changer 24 can restart the reception processing, which is carried out by the communication processor 31, by changing the reception state of the target session from the partial stop to the normal state when the change processing is terminated (step S16).

In this manner, the buffer changer 24 can control the communication processor 31 by changing the session information. However, the control method is not limited to this, and an arbitrary existing method can be employed.

As described above, the communication device according to the present embodiment can change the reception buffer of the target session without discarding the reception data which is in process of reception. By virtue of this, according to the present embodiment, waste of the reception processing can be reduced. According to the present embodiment, the SACK option of TCP can be utilized.

The buffer change method according to the present embodiment can be applied also to a case in which an empty area is generated in the reception buffer due to loss of the reception data or a change(s) in the arrival sequence of the reception data.

### Third Embodiment

A communication device according to a third embodiment will be described with reference to FIG. 10. Since the configuration of the communication device according to the present embodiment is the same as that of the first embodiment, the description thereof is omitted. Hereinafter, it is assumed that the reception buffer is a ring buffer.

In the second embodiment, the change method of changing the reception buffer after the reception data corresponding to the empty area is received in the case in which the empty area is generated in the reception buffer has been described. On the other hand, in the present embodiment, a change method of changing the reception buffer after the reception data written to the used area after the empty area is copied in the case in which the empty area is generated in the reception buffer will be described.

FIG. 10 is a flow chart showing an example of a change operation of the reception buffer of the communication device according to the present embodiment. The flow chart of FIG. 10 is a flow chart in which step S19 is added between step S12 and step S13 of the flow chart of FIG. 4. Steps S11 to S16 of FIG. 10 are the same as those of FIG. 4. Hereinafter, step S19 will be described.

After the reception processing by the communication processor 31 is stopped, the buffer changer 24 copies at least part of the reception data, which is stored in the reception buffer of the target session, to another storage area. In this process, the buffer changer 24 may copy the reception data which is stored in the used area after the empty area (the reception data 2 in FIG. 6) or may copy all the reception data. The other storage area may be a storage area reserved as a reception buffer after change by the application unit 21 or the buffer changer 24 or may be a storage area different from the reception buffer area 11.

The processing thereafter is the same as that of FIG. 4. More specifically, the reader 23 reads the reception data until the reception buffer of the target session becomes empty (step S14), the buffer changer 24 changes the reception buffer of the target session (step S15), and the buffer changer 24 causes the communication processor 31 to restart the reception processing (step S16).

If the other storage area is the storage area different from the reception buffer area 11, the buffer changer 24 can copy the reception data, which has been copied to the other storage area, to the changed reception buffer before the communication processor 31 is caused to restart the reception processing.

As described above, the communication device according to the present embodiment can change the reception buffer of the target session without discarding the reception data in process of reception. By virtue of this, according to the present embodiment, waste of the reception processing can be reduced. According to the present embodiment, the SACK option of TCP can be utilized.

The buffer change method according to the present embodiment can be applied also to a case in which an empty area is generated in the reception buffer due to loss of the reception data or a change in the arrival sequence of the reception data.

### Fourth Embodiment

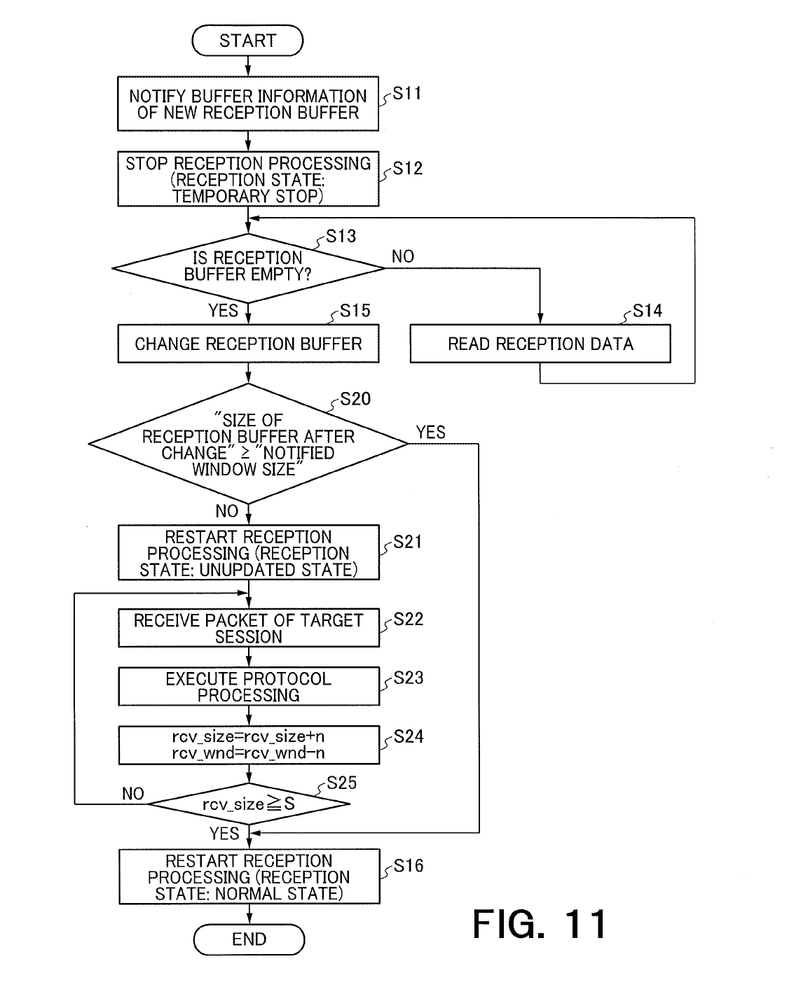

A communication device according to a fourth embodiment will be described with reference to FIG. 11 to FIG. 14. In TCP, a window size of the communication device of a reception side (the size of an empty area in the reception buffer) is notified to a communication device of a transmission side, and flow control is carried out so that the communication device of the transmission side does not transmit data more than the notified window size. Therefore, if the size of the reception buffer is reduced during reception processing like the above described embodiments, the changed window size becomes smaller than the notified window size, and a protocol violation is caused. Therefore, in the present embodiment, a change method of the reception buffer in which a case that the size of the changed reception buffer becomes smaller than the notified window size is taken into consideration will be described. Since the configuration of the communication device according to the present embodiment is the same as the first embodiment, description thereof is omitted.

In the present embodiment, the reception state included in the session information may have three types of values, i.e., a normal state, a temporary stop, and an unupdated state. If the reception state is the unupdated state, the communication processor 31 does not update the window size even when the reception buffer is freed.

FIG. 11 is a flow chart showing an example of a change operation of a reception buffer of a communication device according to the present embodiment. The flow chart of FIG. 11 is a flow chart in which steps S20 to S25 are added between step S15 and step S16 of the flow chart of FIG. 4. Steps S11 to S16 of FIG. 11 are the same as those of FIG. 4. Hereinafter, steps S20 to S25 will be described.

When the buffer changer 24 changes the reception buffer of the target session, the buffer changer 24 compares the size of the changed reception buffer and the window size notified to the external device (step S20).

If the size of the changed reception buffer is equal to or more than the notified window size (YES in step S20), the buffer changer 24 changes the reception state of the target session from the temporary stop to the normal state and causes the communication processor 31 to restart the reception processing (step S16). If the reception state is the normal state, when the reception buffer is freed, the communication processor 31 updates the window size. More specifically, the communication processor 31 notifies the size of the empty area of the freed reception buffer to the external device as a window size. On the other hand, if the size of the changed reception buffer is smaller than the notified window size (NO in step S20), the buffer changer 24 changes the reception state of the target session from the temporary stop to the unupdated state and causes the communication processor 31 to restart the reception processing (step S21). If the reception state is the unupdated state, when the reception buffer is freed, the communication processor 31 does not update the window size. More specifically, the communication processor 31 does not notify the size of the empty area of the freed reception buffer to the external device by “ACK” as a window size. The buffer changer 24 sets the values of “S” and “rcv_size” included in the session information of the target session.

“S” is the difference between the size of the changed reception buffer and the notified window size. If the size of the changed reception buffer is “buf_size” and if the notified window size is “rcv_wnd”, the value of “S” is set to “rcv_wnd-buf_size”. “S” is calculated only once when the reception state is changed to the unupdated state.

“rcv_size” is the size of the entire reception data received by the communication device in the unupdated state. In step S21, the value of “rcv_size” is set to “0”. “rcv_size” is updated every time reception data is received by the communication processor 31 in the unupdated state.

When the reception processing is restarted, the communication processor 31 receives a packet of the target session from the external device (step S22) and executes protocol processing with respect to the reception packet (step S23). As a result, the reception data included in the reception packet is written to the reception buffer.

Then, the communication processor 31 updates “rcv_size” and “rcv_wnd”. If the size of the reception data is “n”, “rcv_size=rcv_size+n” and “rcv_wnd=rcv_wnd-n” are obtained (step S24). The communication processor 31 notifies updated “rcv_wnd” as a window size by “ACK”.

After the communication processor 31 updates “rcv_size” and “rcv_wnd”, the buffer changer 24 compares “rcv_size” with “S”.

If “rcv_size” is equal to or more than “S” (YES in step S25), the buffer changer 24 changes the reception state of the target session to the normal state and causes the communication processor 31 to restart the normal reception processing (step S16).

The case in which “rcv_size” is equal to or more than “S” corresponds to a case in which “buf_size” is equal to or more than the notified window size “rcv_wnd” (buf_size≧rcv_wnd). In this case, the above described protocol violation is solved.

On the other hand, if “rcv_size” is smaller than “S” (NO in step S25), the buffer changer 24 continues to maintain the unupdated state as the reception state of the target session. Then, the communication processor 31 receives a next packet (step S22).

The case in which “rcv_size” is smaller than “S” corresponds to a case in which “buf_size” is smaller than the notified window size “rcv_wnd” (buf_size<rcv_wnd). In this case, the above described protocol violation is not solved.

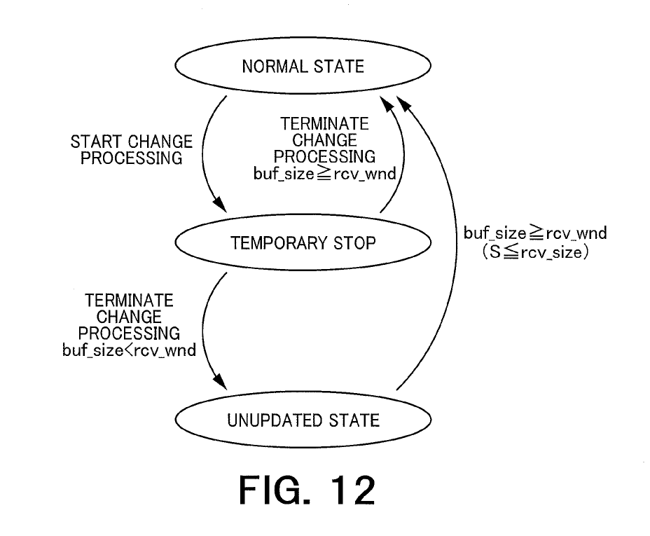

FIG. 12 is a state transition diagram showing transitions of the reception state in the present embodiment. In the example of FIG. 12, the reception state may have three types of values, i.e., the normal state, the temporary stop, and the unupdated state. As shown in FIG. 12, when the change processing of the reception buffer is started, the buffer changer 24 changes the reception state from the normal state to the temporary stop. If the change processing of the reception buffer is terminated and if “buf_size” is equal to or more than the notified window size “rcv_wnd”, the buffer changer 24 changes the receptions state from the temporary stop to the normal state. If the change processing of the reception buffer is terminated and if “buf_size” is smaller than the notified window size “rcv_wnd”, the buffer changer 24 changes the receptions state from the temporary stop to the unupdated state. If the change processing of the reception buffer is terminated and if “buf_size is equal to or more than the window size “rcv_wnd” after the reception state is changed to the unupdated state (a case in which “rcv_size≧S”), the buffer changer 24 changes the reception state from the unupdated state to the normal state.

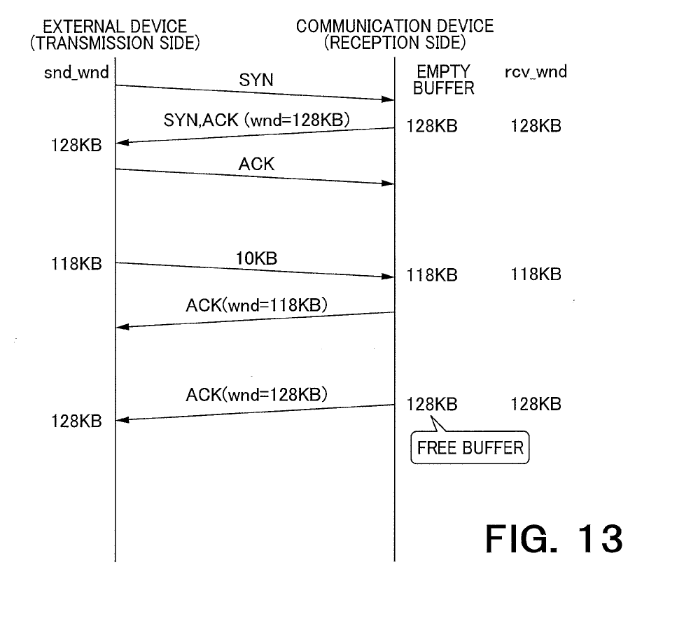

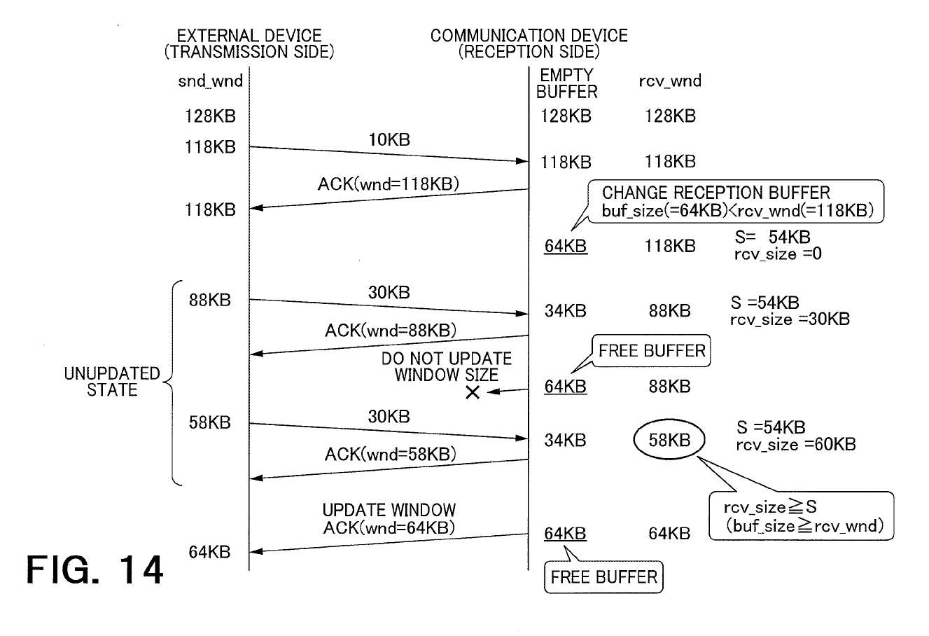

Herein, a specific example of the change operation of the above described reception buffer will be described with reference to FIG. 13 and FIG. 14. FIG. 13 and FIG. 14 are sequence diagrams showing an example of transmission/reception of packets between the communication device according to the present embodiment and the external device in the target session. “snd_wnd” in FIG. 13 and FIG. 14 represents the window size of the reception buffer recognized by the external device, and “empty buffer” represents the size of an actual empty area in the reception buffer. The empty buffer corresponds to the actual window size.

In the example of FIG. 13, first, the external device and the communication device establish a TCP connection by transmitting/receiving SYN and SYN_ACK. At this point, the session state is set to the normal state.

When the TCP connection is established, the communication device reserves a reception buffer of 128 KB. At this point, “rcv_wnd” is 128 KB (“rcv_wnd”=128 KB). The communication device notifies this “rcv_wnd” to the external device by “SYN_ACK”. As a result, the external device recognizes the window size of the reception buffer as 128 KB (“snd_wnd”=128 KB).

After the TCP connection is established, the external device transmits data of 10 KB. At this point, the external device updates “snd_wnd” to 118 KB (=128 KB−10 KB) (“snd_wnd”=118 KB). When the communication device receives this data and writes the data to the reception buffer, the empty buffer becomes 118 KB (=128 KB−10 KB). The communication device updates “rcv_wnd” to 118 KB and notifies updated “rcv_wnd” to the external device by “ACK” (“rcv_wnd”=118 KB). At this point, “snd_wnd” and “rcv_wnd” match each other.

Then, when the reader 23 reads the reception data from the reception buffer and frees the reception buffer, the empty buffer becomes 128 KB. The communication device updates “rcv_wnd” to 128 KB and notifies updated “rcv_wnd” to the external device by “ACK” (“rcv_wnd”=128 KB). The external device to which “rcv_wnd” is notified updates “snd_wnd” to 128 KB (“snd_wnd”=128 KB).

Subsequently, as shown in FIG. 14, the external device transmits data of 10 KB. At this point, the external device updates “snd_wnd” to 118 KB (=128 KB−10 KB) (“snd_wnd”=118 KB). When the communication device receives this data and writes the data to the reception buffer, the empty buffer becomes 118 KB (=128 KB−10 KB). The communication device updates “rcv_wnd” to 118 KB and notifies updated “rcv_wnd” to the external device by “ACK” (“rcv_wnd”=118 KB). At this point, “snd_wnd” and “rcv_wnd” match each other.

In the example of FIG. 14, then, the communication device changes the reception buffer (steps S11 to S15). “buf_size” is 64 KB and is smaller than the notified window size 118 KB (NO in step S20). Therefore, the buffer changer 24 changes the reception state to the unupdated state and sets the values of “S” and “rcv_size” (step S21). At this point, “S” is set to 54 KB (=118 KB−64 KB), and “rcv_size” is set to 0 KB.

Then, the external device transmits data of 30 KB. At this point, the external device updates “snd_wnd” to 88 KB (=118 KB−30 KB) (“snd_wnd”=88 KB). When the communication device receives this data and writes the data to the reception buffer, the empty buffer becomes 34 KB (=64 KB−30 KB). However, if the empty buffer is notified to the external device as a window size, a protocol violation occurs as described above.

Therefore, in the case of the unupdated state, the communication device updates “rcv_wnd” based on notified “rcv_wnd” and notifies updated “rcv_wnd” to the external device as a window size (step S24). In the example of FIG. 14, the communication device updates “rcv_wnd” to 88 KB (=118 KB−30 KB) and notifies updated “rcv_wnd” to the external device by “ACK” (“rcv_wnd”=88 KB). As a result, “snd_wnd” and “rcv_wnd” match each other, and, therefore, the protocol violation is not caused. The communication device updates “rcv_size” to 30 KB (=0 KB+30 KB).

Then, the communication device compares “rcv_size” with “S” (step S25). At this point, since “S” (=54 KB) is larger than “rcv_size” (=30 KB) (NO in step S25), the communication device continues the reception processing while keeping the unupdated state as the reception state.

Herein, when the reader 23 reads the reception data from the reception buffer and frees the reception buffer, the empty buffer becomes 64 KB. However, since the reception state is the unupdated state, the communication device does not update the window size. More specifically, the communication device does not notify the new empty buffer to the external device by “ACK”.

Then, the external device transmits data of 30 KB. At this point, the external device updates “snd_wnd” to 58 KB (=88 KB−30 KB) (“snd_wnd”=58 KB). When the communication device receives this data and writes the data to the reception buffer, the empty buffer becomes 34 KB (=64 KB−30 KB). However, if this empty buffer is notified to the external device as a window size, a protocol violation is caused as described above.

Therefore, in the case of the unupdated state, the communication device updates “rcv_wnd” based on notified “rcv_wnd” and notifies updated “rcv_wnd” to the external device as a window size (step S24). In the example of FIG. 14, the communication device updates “rcv_wnd” to 58 KB (=88 KB−30 KB) and notifies updated “rcv_wnd” to the external device by “ACK” (“rcv_wnd”=58 KB). As a result, “snd_wnd” and “rcv_wnd” match each other, and, therefore, a protocol violation is not caused. The communication device updates “rcv_size” to 60 KB (=30 KB+30 KB).

Then, the communication device compares “rcv_size” with “S” (step S25). At this point, since “S” (=54 KB) is equal to or less than “rcv_size” (=60 KB) (YES in step S25), the communication device changes the reception state from the unupdated state to the normal state and continues the reception processing (step S16).

Herein, when the reader 23 reads the reception data from the reception buffer and frees the reception buffer, the empty buffer becomes 64 KB. At this point, since the reception state is the normal state, the communication device updates “rcv_wnd” to the empty buffer (=64 KB), which is an actual window size, and notifies updated “rcv_wnd” to the external device by “ACK” (“rcv_wnd”=64 KB). The external device to which “rcv_wnd” is notified updates “snd_wnd” to 64 KB (“snd_wnd”=64 KB). Thereafter, the communication device continues the reception processing in the normal state. As described above, if the size of the reception buffer is smaller than the window size, the communication device according to the present embodiment does not update the window size even when the reception buffer is freed. By virtue of this, even in a case in which communication with the external device is carried out by utilizing a communication protocol such as TCP which carries out flow control, the communication device can execute reception processing without causing a protocol violation.

### Fifth Embodiment

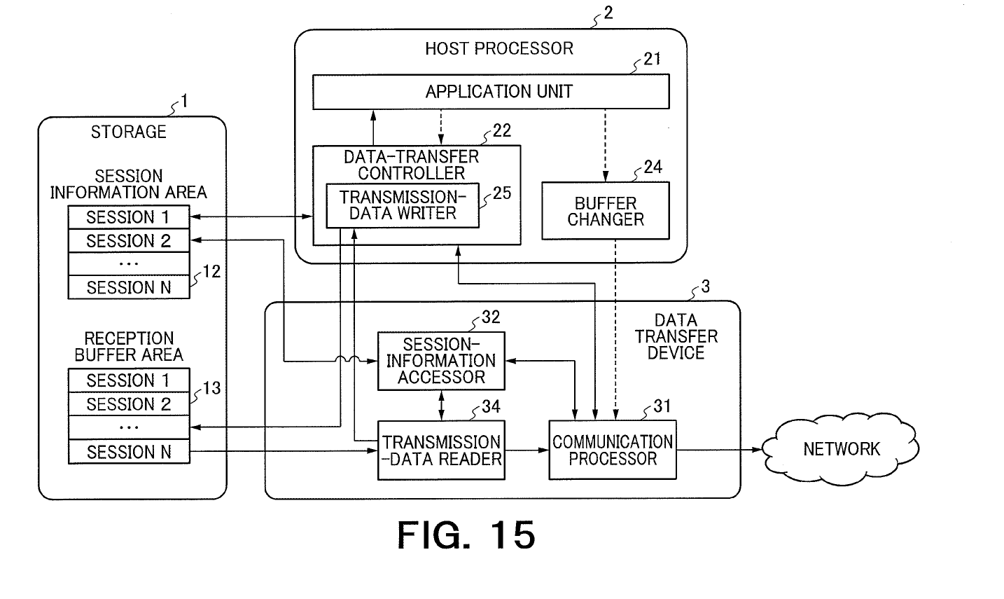

A communication device according to a fifth embodiment will be described with reference to FIG. 15 to FIG. 17. The communication device according to the present embodiment stores data generated by an application into a transmission buffer, executes protocol processing with respect to the data stored in the transmission buffer, and transmits packets, which are obtained by the protocol processing, to an external device (another communication device of a reception side) connected via a network. The communication device according to the present embodiment is capable of dynamically controlling the size of the transmission buffer during transmission processing.

The above described network includes an arbitrary wired communication network and wireless communication network such as Ethernet and wireless LAN. Hereinafter, the packets transmitted by the communication device will be referred to as transmission packets, and the data prepared by the application will be referred to as transmission data. The communication device may transmit frames instead of the packets.

The communication device according to the present embodiment consists of, for example, a PC, a server device, a dedicated LSI, a FPGA (Field Programmable Gate Array), or an ASIC (Application Specific Integrated Circuit), but is not limited thereto.

FIG. 15 is a diagram showing an example of the communication device according to the present embodiment. The communication device of FIG. 15 is provided with the storage 1, the host processor 2, and the data transfer device 3. Hereinafter, the points different from the first embodiment will be mainly described.

The storage 1 is provided with a transmission buffer area 13 instead of the reception buffer area 11.

The transmission buffer area 13 is a storage area in which transmission buffers of sessions are provided. The transmission buffers of the sessions temporarily store transmission data transmitted in the sessions, respectively. In the example of FIG. 15, in the transmission buffer area 13, transmission buffers of a session 1 to a session N are provided.

In the present embodiment, the session information area 12 stores session information including buffer information of the transmission buffers.

The host processor 2 is provided with a transmission-data writer 25 instead of the reception-data reader 23.

The transmission-data writer 25 (hereinafter, referred to as “writer 25”) writes transmission data, which has been received from the application unit 21, to the transmission buffers.

In the present embodiment, the application unit 21 is realized by executing a predetermined application by the host processor 2. The application is arbitrary as long as it transmits data to the external devices.

The transfer device 3 is provided with a transmission-data reader 34 instead of the writer 33. The transmission-data reader 34 (hereinafter, referred to as “reader 34”) reads the transmission data stored in the transmission buffers by utilizing the buffer information and pass the data to the communication processor 31.

In the present embodiment, the communication processor 31 communicates with the external devices by utilizing the session information. The communication processor 31 executes protocol processing with respect to the transmission data received from the reader 34, generates transmission packets, and transmits the transmission packets to the external devices. Next, operations of the communication device according to the present embodiment will be described. Hereinafter, a normal transmission operation of the communication device and a change operation of the transmission buffer will be described.

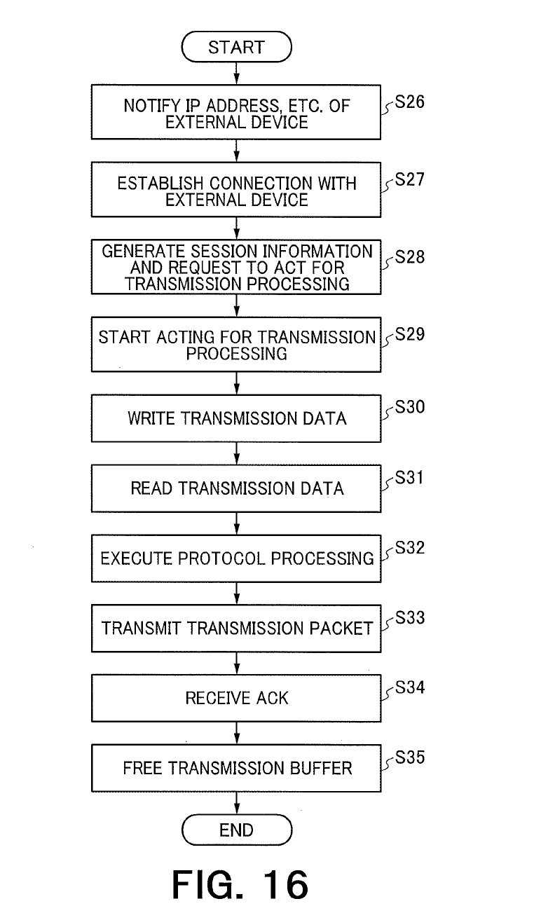

FIG. 16 is a flow chart showing an example of the normal transmission operation of the communication device.

Hereinafter, a case in which protocol processing of TCP/IP is executed with respect to transmission data is taken as an example to give description. It is assumed that the transmission buffer is a ring buffer and that the buffer information includes a read position and a write position of the transmission buffer.

First, the application unit 21 notifies the information required for transmission of data such as an IP address and a port number of the external device to the controller 22 and orders the controller 22 to transmit data (step S26).

Then, in accordance with the order from the application unit 21, the controller 22 establishes connection with the external device (step S27).

When the establishment of the connection is completed, the controller 22 generates session information of the established connection and stores the generated session information in the session information area 12. The controller 22 requests the transfer device 3 to act for transmission processing of a session corresponding to the established connection (step S28). Hereinafter, the session for which the transfer device 3 is requested by the controller 22 to act for transmission processing will be referred to as an acting session.

In this process, the controller 22 reserves a transmission buffer, which temporarily stores transmission data of the acting session, in the transmission buffer area 13. The buffer information of the reserved transmission buffer is included in the session information of the acting session. The reception/transmission of the transmission data between the controller 22 and the transfer device 3 is carried out via this transmission buffer. The transmission buffer can be managed by a method similar to that of the reception buffer.

The communication processor 31 requested to act therefor starts acting for the transmission processing of the acting session (step S29).

Then, when the transmission data of the target session is received from the application unit 21, the writer 25 writes the received transmission data to the transmission buffer of the target session (step S30). When the write of the transmission data is completed, the writer 25 updates the write position included in the session information of the target session. If the transmission buffer of the acting session does not have an empty area to which the transmission data can be written, the writer 25 may wait to write the transmission data until an empty area to which the transmission data can be written is generated. The writer 25 may monitor the buffer information of the acting session and detect generation of the empty area to which the transmission data can be written. The communication processor 31, which has received “ACK” from the external device, may notify a fact that the empty area to which the transmission data can be written is generated to the writer 25. “ACK” received by the communication processor 31 will be described later in detail.

When the transmission data is written to the transmission buffer, the reader 34 reads the transmission data written to the transmission buffer and passes the read transmission data and information identifying the acting session (for example, a session identifier) to the communication processor 31 (step S31).

The reader 34 may monitor the buffer information of the acting session and detect a fact that the transmission data is written. Every time write of the transmission data is completed, the writer 25 may notify the fact that the transmission data has been written to the reader 34. Every time the size of the transmission data written to the transmission buffer exceeds a predetermined size, the writer 25 may notify the fact that the transmission data has been written to the reader 34. The predetermined size may be set in advance, or may be notified from the controller 22 when the connection is established.

The communication processor 31 which has received the transmission data executes protocol processing of TCP/IP with respect to the received transmission data based on the session information of the acting session acquired via the accessor 32 (step S32). Specifically, for example, addition of a TCP header to the transmission data is carried out. As a result, a transmission packet including the transmission data is generated.

After the transmission packet is generated, the communication processor 31 transmits the transmission packet to the external device via the network (step S33).

When the transmission packet transmitted by the communication device is received, the external device executes protocol processing with respect to the transmission packet, extracts the transmission data, generates “ACK” indicating reception of the transmission data, and transmits generated “ACK”. Then, the communication processor 31 receives “ACK” transmitted by the external device (step S34).

When “ACK” is received, the communication processor 31 updates the read position of the acting session and frees the transmission buffer (step S35). More specifically, in the present embodiment, the communication processor 31 frees the transmission buffer after it is confirmed that retransmission of the transmission data is no longer required.

When transmission of all the transmission data is completed by the above transmission operation, the controller 22 notifies the fact that the transmission has been completed to the application unit 21.

By virtue of the transmission operation above, the transfer device 3 can execute the transmission processing of the acting session in place of the host processor 2. In the same connection, the transmission data is received/transmitted by utilizing the same transmission buffer. Therefore, the host processor 2 can efficiently pass the transmission data to the transfer device 3.

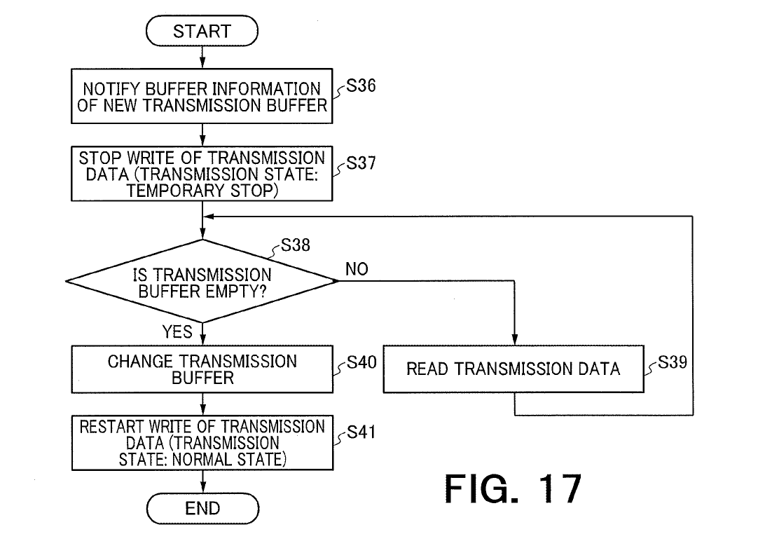

FIG. 17 is a flow chart showing an example of the change operation of the transmission buffer of the communication device according to the present embodiment. The change operation of the transmission buffer is carried out during execution of the transmission processing, which is carried out by the communication processor 31.

First, the application unit 21 specifies a session for which the transmission buffer is to be changed among acting sessions and orders the buffer changer 24 to change the transmission buffer. In this process, the application unit 21 notifies the buffer information of a changed new transmission buffer to the buffer changer 24 (step S36). Hereinafter, the acting session in which the transmission buffer is changed will be referred to as a target session.

The application unit 21 may reserve the new transmission buffer in the transmission buffer area 13 and notify the buffer information of the reserved transmission buffer. The application unit 21 may notify the size of the new transmission buffer without reserving the new transmission buffer. In this case, reservation of the new transmission buffer may be carried out by the buffer changer 24.

The buffer changer 24 ordered to change the transmission buffer stops the write of the transmission data which is carried out by the writer 25 (step S37). As a result, new write of the transmission data to the transmission buffer is stopped. The buffer changer 24 can control the writer 25 by updating the session information as well as the control method of the transfer device 3 described in the first embodiment.

Specifically, the session information includes a transmission state which may have two types of values, i.e., a temporary stop and a normal state as the information indicating the state of the session. The writer 25 stops the write of the transmission data if the transmission state is the temporary stop and writes the transmission data if the transmission state is the normal state. The buffer changer 24 can control the writer 25 by updating the transmission state of the target session.

After the write of the transmission data is stopped, if the transmission buffer is not empty (NO in step S38), the reader 34 continues to read the transmission data from the transmission buffer of the target session (step S39). When the reader 34 continues reading, the transmission buffer becomes empty in the end.

If the transmission buffer becomes empty (YES in step S38), the buffer changer 24 updates the buffer information of the target session based on the buffer information notified from the application unit 21 and changes the transmission buffer of the target session to the new transmission buffer (step S40).

Specifically, if the buffer information of the new transmission buffer reserved by the application unit 21 has been notified, the buffer changer 24 can write the notified buffer information to the session information area 12 as the buffer information of the target session. If the size of the new transmission buffer has been notified, the buffer changer 24 can reserve a new transmission buffer having the notified size and write the buffer information of the reserved transmission buffer to the session information area 12 as the buffer information of the target session.

The buffer changer 24 may detect the fact that the transmission buffer has become empty by monitoring the state of the transmission buffer of the target session or may be notified by the reader 34 that transmission buffer has become empty.

After the transmission buffer of the target session is changed, the buffer changer 24 restarts the write of the transmission data by the writer 25 (step S41).

As described above, the communication device according to the present embodiment can change the transmission buffer of the target session during the transmission processing of the target session. More specifically, the communication device according to the present embodiment can dynamically control the size of the transmission buffer during the transmission processing. By virtue of this, the size of the transmission buffer can be controlled in accordance with the usage rate of the memory (the transmission buffer area 13 of the storage 1), the network throughput, etc., and the usage efficiency of the memory can be improved.

The communication device according to the present embodiment can form the transfer device 3 by a TOE, which reserves transmission buffers having fixed lengths. When the transfer device 3 is formed by such a TOE, the protocol processing is offloaded from the host processor 2, the protocol processing is speeded up, and the communication device having high usage efficiency of the memory can be realized.

The first embodiment and the fifth embodiment can be combined. In this case, the communication device is only required to be provided with the reception buffer area 11, the transmission buffer area 13, the reader 23, the writer 25, the writer 33, and the reader 34. By virtue of this, a communication device capable of dynamically controlling the size of the transmission/reception buffer during transmission/reception processing can be realized.

Terms which are used in the present embodiment should be interpreted broadly. For example, the term “processor” may include a general-purpose processor, a Central Processing Unit (CPU), a microprocessor, a digital signal processor (DSP), a controller, a microcontroller, a state machine or the like. The “processor” may also indicate such as an application specific integrated circuit, a Field Programmable Gate Array (FPGA), a Programmable Logic Device (PLD) or the like depending on situations. The “processor” may also indicate a combination of processing devices such as a plurality of microprocessors, a combination of a DSP and a microprocessor or one or more microprocessors which operate/operates with a DSP core. The term “circuitry” may refer to not only electric circuits or a system of circuits used in a device but also a single electric circuit or a part of the single electric circuit. Moreover, the term “circuitry” may refer one or more electric circuits disposed on a single chip, or may refer one or more electric circuits disposed on a plurality of chips more than one chip or a plurality of devices in a dispersed manner.

As another example, a term “memory” may include an arbitrary electronic component which can store electronic information. The “memory” may indicate such as a Random Access Memory (RAM), a Read Only Memory (ROM), a Programmable Read Only Memory (PROM), an Erasable Programmable Read Only Memory (EPROM), an Electric Erasable Programmable Read Only Memory (EEPROM), a Non Volatile Random Access Memory (NVRAM), a flash memory, a/an magnetic or optical data storage, and they are readable by the processor. If the processor performs reading or writing information to the memory or performs both of them, it can be said that the memory electrically communicates with the processor. The memory may be integrated to the processor, and also in this case, it can be also said that the memory electrically communicates with the processor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A communication device comprising:
a communication processor configured to execute at least one of transmission processing and reception processing of a packet;
writer circuitry configured to write data included in the packet to a buffer;
reader circuitry configured to read the data from the buffer; and
processing circuitry configured to stop at least part of the write to the buffer, change the buffer after the buffer becomes empty, and restart the write to the changed buffer.

2. The communication device according to claim 1, wherein
the communication processor extracts reception data from a reception packet being a packet received by the reception processing;
the writer circuitry writes the reception data to a reception buffer;
the reader circuitry reads the reception data from the reception buffer; and
the processing circuitry stops at least part of the reception processing of the reception packet, changes the reception buffer after the reception buffer becomes empty, and restarts the stopped reception processing.

3. The communication device according to claim 2, wherein
the processing circuitry stops all of the reception processing of the reception packet.

4. The communication device according to claim 2, wherein
the processing circuitry stops the reception processing of the reception packet having a sequence number larger than a maximum sequence number of the reception packet.

5. The communication device according to claim 2, wherein
after the processing circuitry stops the reception processing, the processing circuitry copies at least part of the reception data written to the reception buffer to another storage area.

6. The communication device according to claim 5, wherein
the other storage area is the changed reception buffer.

7. The communication device according to claim 2, wherein,
when a size of the changed reception buffer is smaller than a notified window size, the communication processor does not update the window size even when the reception buffer is freed.

8. The communication device according to claim 2, further comprising:
a host processor provided with the reader circuitry and the processing circuitry and
a hardware data transfer device provided with the writer circuitry and the communication processor; wherein
the communication processor executes the reception processing with respect to the reception packet of a session for which the communication processor is requested by the host processor to act.

9. The communication device according to claim 8, wherein
the data transfer device is a TCP/IP offload engine.

10. The communication device according to claim 1, wherein
the writer circuitry writes transmission data to a transmission buffer;
the reader circuitry reads the transmission data from the transmission buffer;
the communication processor generates a transmission packet from the transmission data by the transmission processing;
the processing circuitry stops at least part of the write of the transmission data, changes the transmission buffer after the transmission buffer becomes empty, and restarts the stopped write of the transmission data.

11. The communication device according to claim 10, further comprising:
a host processor provided with the writer circuitry and the processing circuitry and
a hardware data transfer device provided with the reader circuitry and the communication processor; wherein
the communication processor executes the transmission processing with respect to the transmission data for which the communication processor is requested by the host processor to act.

12. The communication device according to claim 11, wherein
the hardware data transfer device is a TCP/IP offload engine.

13. A communication method comprising:
stopping, during execution of at least one of transmission processing and reception processing of a packet, at least part of write of data included in the packet to a buffer;
continuing to read the data from the buffer during the execution;
changing the buffer after the buffer becomes empty during the execution; and
restarting the write to the changed buffer during the execution.

14. A non-transitory computer readable medium having a computer program stored therein which when executed by a computer, causes the computer to perform processing of steps comprising:
stopping, during execution of at least one of transmission processing and reception processing of a packet, at least part of write of data included in the packet to a buffer;
continuing to read the data from the buffer during the execution;
changing the buffer after the buffer becomes empty during the execution; and
restarting the write to the changed buffer during the execution.
